(19) United States
(12) Patent Application Publication
(10) Pub. No.: US 2026/0119807 A1
(43) Pub. Date: Apr. 30, 2026

(54) APPARATUS AND METHOD FOR IMPROVING CONVERSATION ANALYSIS

(71) Applicant: Calabrio, Inc., Minneapolis, MN (US)

(72) Inventors: Alexander Kvamme, Minneapolis, MN (US); John Doig, III, Minneapolis, MN (US)

(21) Appl. No.: 19/291,000

(22) Filed: Aug. 5, 2025

Related U.S. Application Data
(60) Provisional application No. 63/679,494, filed on Aug. 5, 2024.

(51) Int. Cl. G06F 40/35; G06F 40/40; G06N 3/09

(52) U.S. Cl. CPC G06F 40/35; G06F 40/40; G06N 3/09

(57) ABSTRACT

Systems and methods are disclosed for improving conversation analysis using lightweight, custom models trained with limited human-labeled data. A conversation object comprising natural language data is processed using an analysis model to generate attribute values. Human feedback is received to correct or confirm the attribute values. A foundation model is then prompted to generate synthetic training examples based on the conversation object and evaluator input. A custom analysis model is trained using both the human-labeled and synthetic data and is deployed when performance exceeds a predefined threshold. The system may support segment-based corrections, structured refinement data storage, and per-entity model deployment. These techniques enable high-accuracy attribute prediction in domains where training data is sparse and generic models underperform. The disclosed approach reduces annotation costs, enhances model precision, and supports scalable, domain-specific customization of conversation intelligence pipelines.

### CROSS-REFERENCE TO RELATED APPLICATIONS

This application claims priority to and the benefit of U.S. Provisional Patent Application No. 63/679,494, filed Aug. 5, 2024 and titled “A Method for Improving Conversation Analysis,” the entire disclosure of which is hereby incorporated by reference in its entirety.

### TECHNICAL FIELD

The present disclosure relates generally to the customer service analytics field, and more specifically to a new and useful method in the customer service analytics field.

### BACKGROUND

In many domains such as customer support, healthcare, and compliance, organizations collect large volumes of conversation data in the form of phone transcripts, chat logs, or email threads. To extract meaningful insights from this unstructured data, natural language processing (NLP) techniques are often employed to identify attributes such as sentiment, escalation risk, intent, and compliance markers.

Conventional conversation analysis systems rely on generic models trained on large, heterogeneous corpora. These models are often capable of detecting general-purpose attributes across diverse domains but tend to underperform when applied to entity-specific requirements. For example, a sentiment classifier trained on open-domain dialogue may fail to detect dissatisfaction expressed in a domain-specific manner, such as technical product support interactions. While it is possible to improve accuracy by fine-tuning models on organization-specific data, such data is often sparse, inconsistently labeled, or prohibitively expensive to annotate at scale.

Foundation models have emerged as powerful tools capable of generating human-like outputs and interpreting complex language patterns. However, these models are computationally intensive, difficult to deploy in production environments, and often require prompting strategies that lack transparency or repeatability. Moreover, the use of foundation models alone does not solve the problem of generating high-accuracy predictions for custom attributes when human-labeled data is limited.

### SUMMARY

The present disclosure provides methods and systems for improving conversation analysis through the generation and deployment of lightweight, custom models that operate with high accuracy in data-constrained environments. In particular, the disclosed techniques enable the extraction of structured attributes from natural language conversations by combining sparse human supervision with synthetically generated training data, resulting in custom models tailored to entity-specific needs.

In one aspect, a method includes receiving a conversation object comprising natural language data from a multi-turn interaction, generating a set of attribute values using an analysis model, and receiving evaluator input to confirm or correct one or more of the attribute values. Based on the evaluator-labeled data, a foundation model is prompted to generate a set of synthetic training examples that emulate the distribution and structure of the corrected inputs. A custom analysis model is then trained using a dataset that includes both the evaluator-labeled examples and the synthetic examples. The resulting custom model may be deployed for future inference tasks when it meets or exceeds a predefined performance threshold.

The systems and methods described herein address the need for accurate and adaptable conversation analysis in scenarios where labeled data is limited. By leveraging foundation models for data synthesis and incorporating structured human feedback, the disclosed techniques enable rapid and cost-effective generation of deployable custom models. These custom models can achieve high prediction accuracy while maintaining computational efficiency suitable for production environments.

Additional advantages of the present disclosure include improved responsiveness to emerging labeling needs, reduced reliance on manual annotation at scale, support for segment-specific attribute correction, and modular deployment architectures for multi-tenant model management. The disclosed principles may be applied across a variety of domains, including, but not limited to, customer service, healthcare communication, compliance auditing, and operational risk monitoring.

### BRIEF DESCRIPTION OF THE FIGURES

FIG. 1 is a schematic representation of a variant of the system.

FIG. 2 is a schematic representation of a variant of S100.

FIG. 3 is a schematic representation of a variant of S200.

FIGS. 4A-D are schematic representations of variants of S220.

FIG. 5 is a schematic representation of a variant of S300.

FIG. 6 is a schematic representation of a variant of S400.

FIG. 7 is an illustrative example of a variant of the method.

FIG. 8 illustrates a simplified block diagram of a device with which aspects of the present disclosure may be practiced in accordance with aspects of the present disclosure.

### DETAILED DESCRIPTION

The following description of embodiments of the present disclosure is not intended to limit the present disclosure to these embodiments, but rather to enable any person skilled in the art to make and use the present disclosure.

### Overview

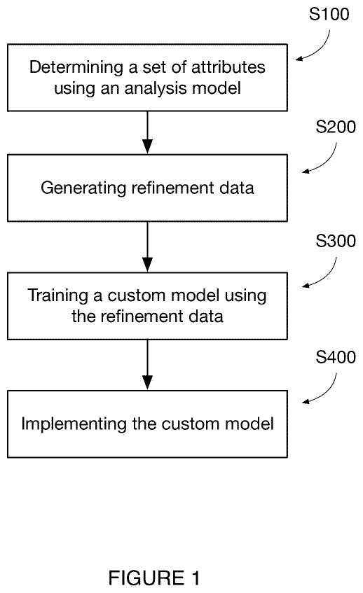

As shown in FIG. 1, the method can include determining a set of attributes using an analysis model S100, generating refinement data based on the set of attributes S200, training a custom model using the refinement data S300, and optionally implementing the custom model S400. The method functions to create small, fast custom models with frontier-model accuracy, using a sparse training data set.

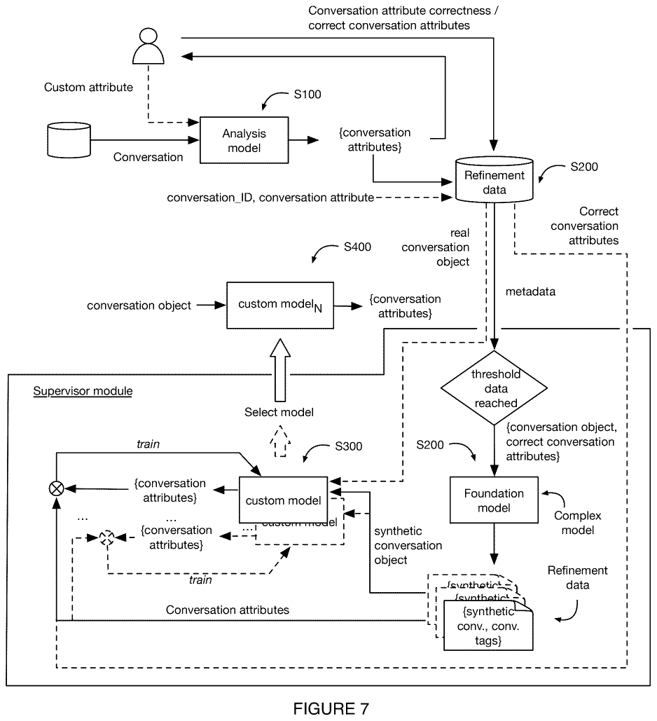

In an illustrative example (e.g., shown in FIG. 7), the method can include running each of a set of conversation objects (e.g., records), each associated with an entity, through an analysis model (e.g., a generic analysis model shared between entities). The analysis model can determine a set of attribute values (e.g., a customer satisfaction rating, the topic of conversation, set of tags or labels, etc.) for each conversation object. In variants, the set of attributes (e.g., set of tags) can include custom attributes that are specific to the entity (e.g., custom tags). An evaluator (e.g., a human evaluator) can determine the correctness of each attribute for the conversation object and/or can provide a corrected attribute for incorrect attributes. When a threshold number of human annotations is obtained for a given attribute (e.g., the custom attribute), a supervisor module can orchestrate custom model generation by: generating a set of refinement data using a frontier model and the human annotations; training (e.g., finetuning) one or more custom models using the set of refinement data; and optionally selecting a custom model (e.g., highest accuracy model) for use when multiple custom models are trained. The (selected) custom model can be used for future attribute extraction from conversation objects, particularly when the custom model is higher quality than the existing analysis model (e.g., better prediction accuracy, better fit, etc.). In variants, the frontier model is substantially larger (e.g., 1× smaller, 10× smaller, 100× smaller, 1000× smaller, etc.), more complicated (e.g., more weights, nodes, layers, connections, variables, etc.), and slower than the custom model and/or analysis model. In variants, the custom model can require substantially more and/or a larger distribution of training data than that provided by the human annotations. In variants, all or portions of the method can be repeated to generate custom models that are higher quality (e.g., higher accuracy, precision, etc.), can accommodate more custom attributes, and/or have other functionalities.

However, the method can be otherwise defined.

### Technical Advantages

Variants of the technology can confer one or more advantages over conventional technologies.

First, variants of the method enable small models to achieve foundation model-levels of prediction accuracy for custom attribute prediction. Small models are oftentimes preferred over foundation models for production, since small models are more computationally efficient and faster to run. However, small models require large volumes of high-quality training data to generate accurate predictions. Unfortunately, many applications, particularly applications where the model needs to predict a custom target (e.g., custom attribute), suffer from sparse data—the amount of training data (and the distribution of training data) that is available is orders of magnitude less than what is needed to train the small model. This technology can bridge this gap by using foundation models to generate large volumes of synthetic training data (e.g., (conversation object, attribute value) pairs) for small model training. For example, a foundation model can be prompted to generate large volumes of synthetic training data using the sparse training data as examples. The small model(s) are then trained on the synthetic training data (e.g., which provides foundation model-level accuracy), and used in production.

However, these are non-limiting examples, and further advantages can be provided by the system and method disclosed herein.

Variants of the method can be used with or implemented using: a set of conversation objects, a set of attributes, a set of analysis models, a supervisor module, a set of foundation models, a set of custom models, and/or other components. analysis model

### System

Conversation objects function to represent a conversation between participants as data. In variants, participants can be people (e.g., customers), automatic systems (e.g., chatbots, LLMs, etc.), groups (e.g., institutions, teams, etc.) and/or any other suitable entity. Conversation objects can be audio files, video files, transcripts, email chains, text chains, survey responses, and/or other representation of a conversation. Conversation objects can be in an original form (e.g., raw data) and/or can be converted into a JSON, encoding, embedding, transcript, feature vector, and/or any other suitable secondary representation. Conversation objects can be used as inputs (e.g., training inputs and/or inference inputs) for analysis models, a complex model, and/or any other suitable model. Conversation objects can be recorded and/or synthetically generated (e.g., by a complex model). Synthetically generated conversation objects can be generated based on a particular set of reference conversation objects (e.g., representing conversations on which a custom model determined a correct or incorrect attribute) and/or can be generated based on any other suitable information. However, conversation objects can be otherwise configured.

Attributes function to represent a dimension of a conversation. Attributes can be qualitative or quantitative. Attributes can be numbers, binary values, embeddings, encodings (e.g., representing a region in a semantic feature space), classifications, text (e.g., human-parseable text), and/or can be in any other suitable form. Attributes can include tone, sentiment, emotion, style, topics, keyword presence, named entities (e.g., using named entity recognition), and/or other attributes (e.g., classes, tags, etc.). The attributes can be: platform-standard, custom (e.g., provided by the entity), learned, and/or otherwise determined.

Attributes can be associated with attribute values, which can represent the data or content of the attribute that appears within the conversation. The attribute values can be: continuous, discrete, binary, categorical, and/or have any other suitable value. In an example, an attribute value can be a number between 0 and 1 representing tone.

However, attributes can be otherwise configured.

The supervisor module can function to orchestrate custom model generation (e.g., custom analysis model generation). The supervisor can trigger custom model generation, determine training data examples, synthetize training data (e.g., S220), control custom model training (e.g., S300), optionally select a custom model (e.g., when multiple custom models are trained), and/or perform any other suitable step of the method. In a first example, the supervisor module initiates custom model generation when a threshold number or frequency of inaccurate attribute determinations have been flagged (e.g., by a user, by another model, etc.). In a second example, the supervisor module initiates cinustom model generation when a threshold volume of training data (e.g., including, but not limited to, correct attribute determinations, corrected attribute determinations, incorrect attribute determinations, etc.) have been aggregated for a given entity or attribute. In these examples, the threshold is preferably substantially lower than the volume of data needed to train or finetune an accurate simple neural network (e.g., 10× less, 100× less, 1000× less, etc.), but can alternatively be approximately the same. In examples, the threshold can be 2, 3, 5, 10, 30, 100, or any other number. The supervisor can use heuristics, can use a model trained to determine when custom model generation should occur and/or whether a particular attribute is inaccurate, can accept a command from a user to generate a custom model and/or can use any other suitable method to trigger custom model generation. However, the supervisor can be otherwise defined.

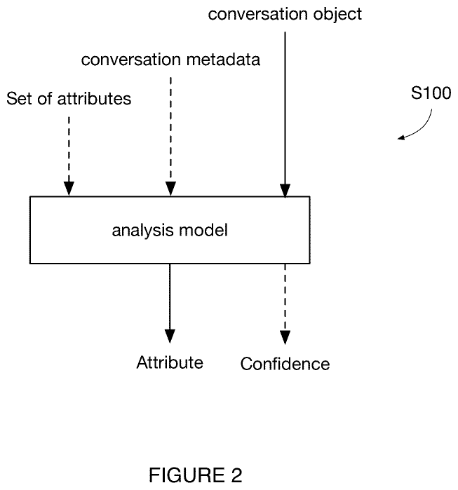

Analysis models function to determine one or more attributes of a conversation (e.g., example shown in FIG. 2). Analysis models can be generic (e.g., trained on a variety of conversation from different companies, conversations from different customer groups, conversations about different topics) or custom (e.g., trained on a particular corpus of conversations in order to improve attribute determination for similar conversations).

The analysis model is preferably a simple neural network (e.g., with a single hidden layer, with less than a threshold number of hidden layers), but can alternatively be a deep neural network (e.g., with more than a threshold number of hidden layers, with multiple hidden layers, etc.), a large neural network (e.g., millions of parameters), a declarative program, a decision tree, a classical machine learning model (e.g., SVM, Bayesian network, etc.), a lightweight model, a domain-specific model, and/or any other model. Examples of simple neural networks can include perceptrons, multilayer perceptrons with one hidden layer, single hidden layer CNNs, and/or other architectures.

The analysis models can be trained (e.g., finetuned, etc.), prompted, or otherwise instructed to predict or infer one or more of the attributes. In a first variant, the attribute value is within the model's training data set, wherein the model is directly trained to predict the attribute value. In a second example, the attribute value is outside of the model's training data set or is given a meaning different from conventional definitions, wherein the model uses transfer learning or attempts to predict the attribute data (e.g., with lower accuracy). For example, the model can be instructed to determine whether a conversation mentions the customer's brand name product (e.g., “Squishee”, “Echo”) and the associated sentiment, where the brand name was not within the model's training data set. In a second variant, the model is prompted to determine whether the conversation object exhibits the attribute value (e.g., using natural language). In an illustrative example, the prompt can include “determine whether the customer mentions “Squishee”, and if so, determine the associated sentiment”. The prompt can be within the model's training data set or outside of the model training data set.

The inputs for the analysis model can include: the conversation object (e.g., the entire conversation, chunks of the conversation, summaries of the conversation, etc.), attribute values, prompts, contextual information about a conversation, conversation metadata, and/or any other suitable information. Analysis models preferably output attributes and/or a set of attributes and can optionally additionally output confidence values and/or any other suitable information.

In a first variant, an analysis model is specific to an attribute, and can determine values specific to the attribute (e.g., whether the sentiment is “positive” or “negative”, whether a tag is mentioned, etc.).

In a second variant, an analysis model can determine values for multiple attributes (e.g., determine multiple conversation attributes). For example, the analysis model can determine sentiment, tone, emotion, and tag values for a conversation object.

However, analysis models can be otherwise configured.

In a first variant, the analysis model is a generic model that is trained on generic data (e.g., not trained on the entity's data or annotations).

In a second variant, the analysis model is a custom model that is trained (e.g., finetuned, trained end-to-end, etc.) on refinement data. Each custom model is preferably specific to an entity, but can alternatively be shared across entities, be specific to an attribute (e.g., set of attribute values), and/or otherwise shared or not shared. The refinement data can include: the entity's annotated data, synthetic data (e.g., generated by a frontier model seeded with the entity's annotated data), and/or other data. The custom model can be a finetuned version of the generic model, a trained version of the generic model (e.g., using the generic model's architecture), a trained version of another model architecture (e.g., perceptron vs. multilayer perceptron vs. single hidden layer CNN, etc.), and/or otherwise defined. The custom model can predict the custom attributes to the same accuracy as the generic attributes, to a higher accuracy, to a lower accuracy, and/or to another accuracy. The custom model can predict: only the custom attribute values, the custom attribute values and the generic attribute values, and/or any other suitable set of output targets. Custom model generation is preferably controlled by the supervisor module, but can alternatively be controlled by the entity and/or by any other suitable component.

The input and/or outputs of a custom model are preferably the same inputs and/or outputs as the analysis model on which it is based but can alternatively be other inputs and/or outputs. However, custom models can be otherwise configured.

The complex model functions to synthesize training data for refining analysis models. The complex model is preferably a frontier model, which can be extremely large (e.g., billions to hundreds of billions of parameters, many hidden layers, orders of magnitude more parameters and/or layers than the analysis models, etc.) and was released within a threshold timeframe from a current date (e.g., 1 mo., 6 mo., 1 year, etc.), but can alternatively be an older model, a smaller model, or be another model. The complex model is preferably a foundation model (e.g., a model trained on a broad set of data for a wide set of use cases, etc.), but can additionally or alternatively be another general-purpose model, a domain-specific model, and/or any other suitable model.

The complex model is preferably used without additional training (e.g., finetuning, etc.), but can alternatively be used after training on refinement data. The complex model is preferably prompted with examples of the custom training data (e.g., manually generated annotations for conversation objects), but can alternatively not be provided examples of target refinement data. In variants, the complex model can be instructed to generate: a predetermined volume of synthetic training data (e.g., conversation object-attribute value pairs), a predetermined distribution of synthetic training data (e.g., across domains, across positive and negative examples, across attribute value permutations, etc.), and/or a synthetic data set with any other suitable set of metadata.

The complex model can determine attributes for a given conversation object, can determine a conversation object for a given attribute, can determine a conversation object and/or an attribute based on similar conversation objects and/or attributes, can modify a conversation object and/or attribute in a conversation object-attribute pair, and/or can otherwise determine conversation object-attribute pairs. However, the complex model can be otherwise configured.

The complex model can determine conversation object-attribute pairs (e.g., synthetic training data), which can be used as custom model training data. The synthetic training data can be determined based on existing conversation object-attribute pairs, based on an attribute-specific prompt, and/or based on any other information.

However, the complex model can be otherwise used.

The system can additionally or alternatively include a user interface, which functions to present attribute values in association with the conversation object or representation thereof (e.g., conversation ID, etc.). The presented attribute values can be: attribute values determined using the generic model, attribute values determined using the custom model, manually-determined attribute values, and/or any other attribute value. The conversation object representations that are presented can include: a transcript of the conversation, audio of the conversation, video of the conversation, summaries of the conversation (e.g., along one or more dimensions, specific to one or more attributes, etc.), snippets of the conversation relevant to the attribute value (e.g., that the analysis model used to determine the attribute value), and/or any other suitable conversation representation. The user interface can optionally include an attribute value feedback interface. The feedback interface can include: a binary correct/not correct annotation for the attribute value; multi-select option to select the correct attribute value (e.g., from a set of predetermined attribute values); a freeform field to enter the correct attribute value; an explanation field to explain why the attribute value is associated with the conversation object; a conversation object interaction field to identify the keywords or segments associated with the attribute value; and/or any other suitable interface element. Feedback received at the user interface (e.g., attribute values, conversation object segments, etc.) can be associated with the conversation object and stored as refinement data, which can be used for custom model training.

However, the system can include any other suitable set of components.

### Method

Variants of the method can include determining a set of attributes using an analysis model S100, generating refinement data based on the set of attributes S200, training a custom model using the refinement data S300, and optionally implementing the custom model S400. The method can be performed during runtime (e.g., during conversation analysis, while the analysis model is in operation, etc.), responsive to a time-based condition, responsive to a command (e.g., from a user), responsive to an error, responsive to an iteration-based condition, and/or at any other suitable time. All or portions of the method can be performed in real time (e.g., responsive to a request), iteratively, concurrently, asynchronously, periodically, and/or at any other suitable time. All or portions of the method can be performed automatically, manually, semi-automatically, and/or otherwise performed. All or portions of the method can be performed by the system described above or be otherwise performed.

Determining a set of attributes using an analysis model S100 functions to generate insights extracted from a conversation object (e.g., attribute values). S100 is preferably performed on real conversation objects (e.g., generated from real conversations between one or more humans), but can additionally or alternatively be performed on synthetic conversations and/or any other data. S100 can be performed in real-time, at a predetermined frequency, when a threshold number of conversations is received for a given entity, and/or at any other time. S100 can be performed using the generic analysis model, using a custom analysis model (e.g., for the entity associated with the conversation objects), and/or using any other model. However, S100 can be otherwise performed.

Generating refinement data S200 functions to generate training data for custom model generation. S200 can be performed using the user interface, the supervisor module, the complex model, and/or any other model. S200 can be continuously performed (e.g., continuously during runtime); iteratively performed (e.g., every N conversations, etc.); performed when a refinement condition is satisfied (e.g., when a user requests custom model generation, when a user adds a new attribute or attribute value, when a threshold number of incorrect attribute values have been marked, etc.); and/or at any other time. S200 is preferably performed after S100 and before S300, but can alternatively be performed after S300 (e.g., to develop higher-accuracy custom models, after more human-labeled refinement data is available, etc.), and/or at any other time. S200 is preferably performed when the amount of refinement data exceeds a threshold (e.g., more than 10 datapoints, etc.), but can be performed when a confidence score or accuracy for one or more attribute value predictions falls below a threshold confidence (e.g., for low-confidence predictions) or accuracy; and/or when any other condition is met. S200 is preferably controlled by the supervisor module, but can alternatively be manually controlled and/or otherwise controlled.

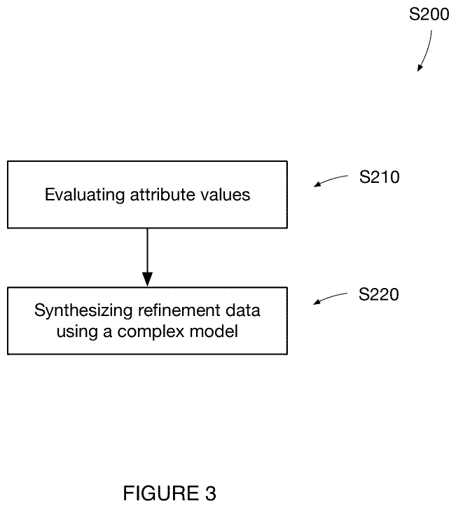

S200 can include evaluating attributes S210 and synthesizing refinement data using a complex model S220 (e.g., example shown in FIG. 3).

Evaluating attributes S210 functions to determine the quality of outputs of an analysis model (e.g., a refined or generic analysis model). The attribute values can be evaluated for: correctness, accuracy, and/or any other metric. S210 can be performed: for every conversation object (e.g., the first 10 conversations); for random conversations; and/or for any other suitable set of conversations. Evaluating attribute values can be performed on the entire set of attributes on subset of the set of attributes (e.g., only the custom attributes), a single attribute, and/or any other set of attributes. In an example, the analysis model outputs values for a plurality of attributes, wherein only custom attribute values (e.g., values for custom attributes; custom values; etc.) are evaluated. However, any other set of attribute values can be evaluated. S210 can be performed once for each attribute or multiple times for each attribute.

The attribute values are preferably evaluated by a human evaluator but can alternatively be performed by a model (e.g., a larger model, a frontier model, etc.). S210 can include: providing the conversation (or representation thereof) and the attribute values to an evaluator (e.g., user, model, etc.), and receiving an evaluation of the attribute value. However, the attribute values can be otherwise evaluated. The evaluation can include a score, binary value (e.g., correct/not correct), qualitative assessment (e.g., text describing problems with an output), a ranking of different attributes for the same prompt, and/or can take any other suitable form.

In an automatic variant, evaluations can be generated by an evaluation model trained on prior evaluations and/or a generic model (e.g.,) not trained on prior evaluations. In a first example, the attribute value(s) can be determined for a conversation object using a large model (e.g., DNN, frontier model, accurate model, etc.), wherein the analysis model-predicted attribute values can be verified against the large model-predicted attribute values. In a second example, the attribute value(s) and the conversation object can be provided to a large model, wherein the large model can generate a characterization of the attribute value(s) for the conversation object. In an illustrative example, this can include prompting an LLM to determine whether the conversation has the attributes.

In a manual variant, the attribute value(s) and the conversation can be provided to a user via the feedback interface, wherein the user can provide the evaluation (e.g., whether the attribute values are correct). In this variant, evaluations can be received from one or more users for a given conversation object, wherein the evaluations can be aggregated (e.g., averaged, ranked, etc.). In an example, a user can correct an attribute value, which can generate two pieces of training data: a negative example (e.g., with the incorrect attribute value) and a positive example (e.g., with the positive attribute value). However, the attribute value evaluations can be otherwise manually determined.

However, the attribute value evaluations can be otherwise determined.

S210 can produce annotated training data. In a first variant, the annotated training data includes conversation object-attribute value set pairs (e.g., a conversation object associated with values for one or more attributes). In a second variant, the annotated training data includes conversation object-attribute value set-annotation tuples (e.g., a conversation object associated with values for one or more attributes and a correctness label for each value). However, the annotated training data can be otherwise structured.

However, S210 can be otherwise performed.

Synthesizing refinement data using a complex model S220 functions to generate training data for training the custom model. Refinement data can include conversation object-attribute value set pairs, explanations, and/or other data. S220 is preferably repeated until a threshold amount of refinement data is generated (e.g., wherein the threshold amount is the amount needed for custom model training), but can be repeated until any other condition is met. S220 preferably includes instructing the complex model to generate refinement data based on the annotated training data. For example, the complex model can be instructed to generate more conversation-attribute value set pairs that are similar to the positive examples (e.g., conversations with correct or corrected attribute value sets), the negative examples (e.g., conversations with incorrect attribute value sets), and/or other examples of training data. The complex model can additionally or alternatively be instructed to generate examples across a different data distribution, across multiple domains, for multiple attributes, and/or otherwise generate refinement data. However, the refinement data can be generated by perturbing the conversation objects, the attribute values (e.g., to generate negative examples from positive examples), and/or otherwise generated.

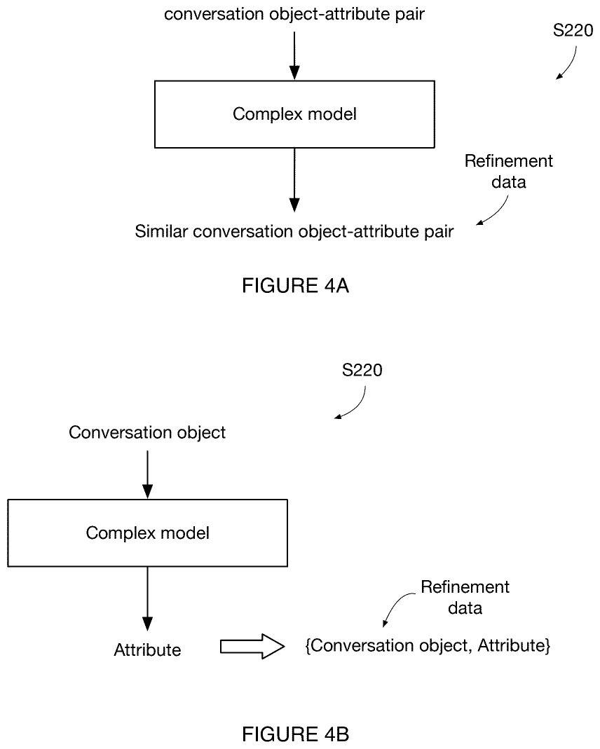

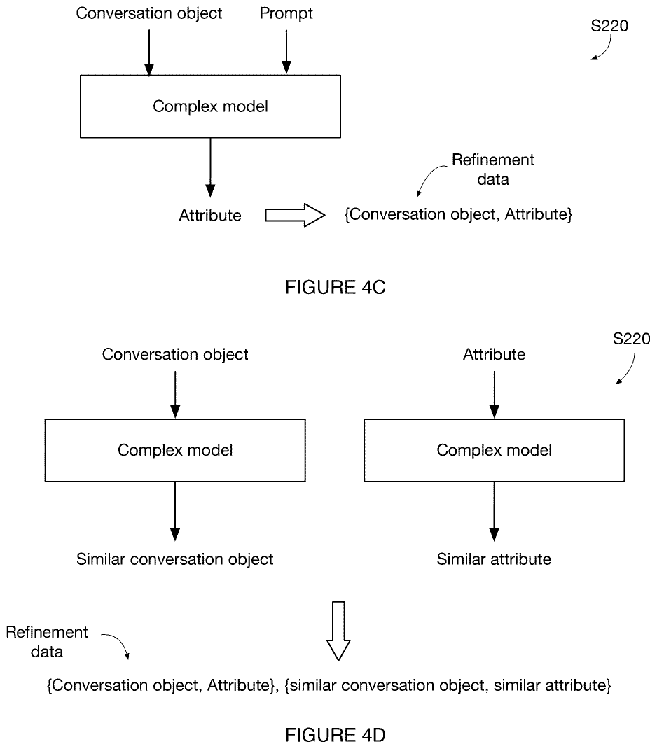

In a first variant, the complex model ingests a conversation object-attribute pair and outputs a similar conversation object-attribute value pair (e.g., example shown in FIG. 4A). In a second variant, the complex model ingests a conversation object and outputs an attribute value (e.g., example shown in FIG. 4B; in this variant, the complex model can be fine-tuned on the attributes and corresponding conversation objects). In a third variant, the complex model ingests a conversation object and a prompt describing the characteristics of the attribute (e.g., “generate a sentiment rating between 0 and 1 for the customer in this conversation”; example shown in FIG. 4C). In a fourth variant, a complex model ingests a conversation object and outputs a similar conversation object; and another complex model (alternatively, the same complex model) ingests an attribute and outputs a similar attribute, which is paired with the similar conversation object and used as refinement data (e.g., example shown in FIG. 4D). However, synthesizing conversation object-attribute pairs using the complex model can be otherwise performed. However, synthesizing refinement data using a complex model S220 can be otherwise performed.

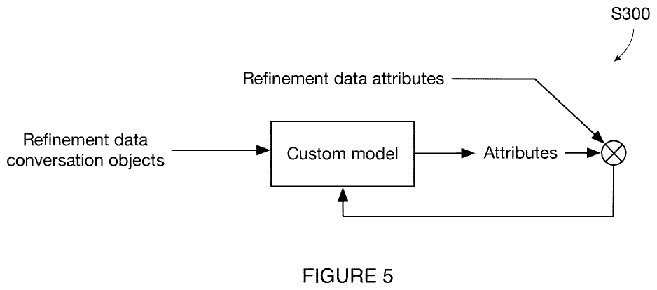

Training a custom model using the refinement data S300 functions to determine a custom analysis model with high attribute prediction accuracy (e.g., examples shown in FIG. 5 and FIG. 7). Training a custom model preferably includes fine-tuning an existing analysis model, but can alternatively include generating a new model altogether. The analysis model (e.g., the model on which fine-tuning is based) is preferably the analysis model previously used to generate the set of attributes, but can alternatively be a generic model or another analysis model. S300 is preferably performed after S200 (e.g., after a threshold amount of refinement data has been generated), but can alternatively be performed at any other suitable time. S300 can be performed one or more times for a given entity and/or refinement data set. In a first example, S300 is repeated using different model architectures. In a second example, S300 is repeated using different refinement data subsets (e.g., with different held-out sets). However, S300 can be otherwise repeated or not repeated. S300 is preferably performed by the supervisor module (e.g., performed automatically), but can alternatively be performed by a user or other system.

In variants, S300 includes: initializing a set of machines, running training jobs on each of the set of machines to train the custom model(s) using the refinement data (and/or subset thereof); evaluating the resultant artifact(s) (e.g., the models) against a held-out set (e.g., the human-annotated set, a randomly-selected set, etc.); and optionally selecting the best-performing model (e.g., most accurate, most precise, highest F1-score, etc.). However, S300 can be otherwise performed.

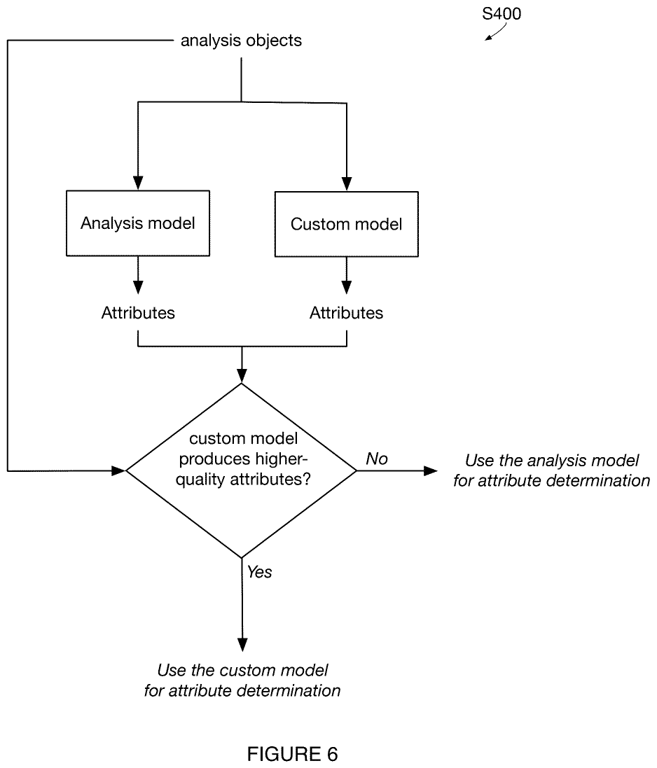

Implementing the custom model S400 functions to use the custom model for analysis, instead of the generic model. S400 can include analyzing all future conversation objects using the custom model, or otherwise using the custom model. S400 can be performed after S300, after validating the custom model (e.g., against validation data), after the custom model has passed a series of checks (e.g., implemented by the supervisor module), after determining that the custom model is more performant than the generic analysis model (e.g., example shown in FIG. 6), and/or at any other suitable time. Other instances of the method can be concurrently performed during S400 (e.g., more evaluations can be collected, more refinement data can be generated, more custom models can be trained, etc.). The custom model can be used alongside other generic models (e.g., for other attributes) to evaluate the conversations for the associated entity. Alternatively, the custom model can be used in lieu of (e.g., replace) the generic models for conversations for the associated entity.

However, the method can be otherwise performed.

All references cited herein are incorporated by reference in their entirety, except to the extent that the incorporated material is inconsistent with the express disclosure herein, in which case the language in this disclosure controls.

Different subsystems and/or modules discussed above can be operated and controlled by the same or different entities. In the latter variants, different subsystems can communicate via: APIs (e.g., using API requests and responses, API keys, etc.), requests, and/or other communication channels. Communications between systems can be encrypted (e.g., using symmetric or asymmetric keys), signed, and/or otherwise authenticated or authorized.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including, but not limited to, one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

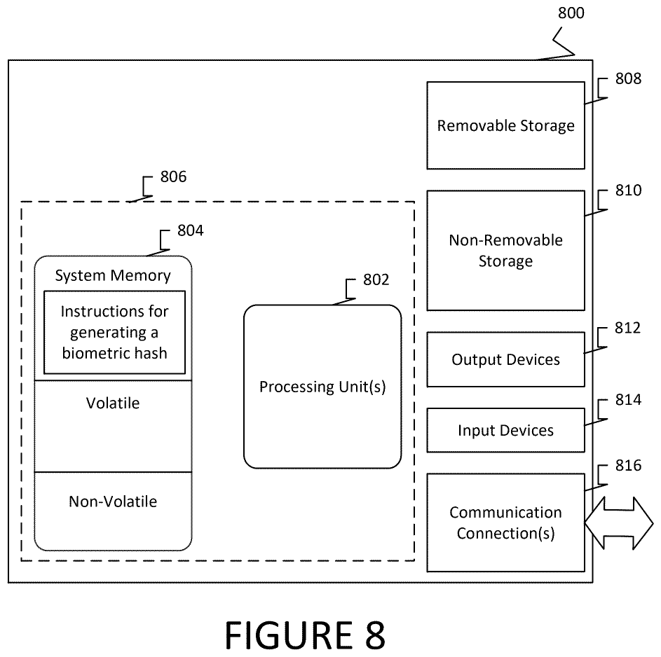

FIG. 8 and the associated descriptions provide a discussion of a variety of operating environments in which aspects of the disclosure may be practiced. However, the devices and systems illustrated and discussed with respect to FIG. 8 are for purposes of example and illustration and are not limiting of a vast number of computing device configurations that may be utilized for practicing aspects of the disclosure, described herein.

FIG. 8 illustrates a simplified block diagram of a device with which aspects of the present disclosure may be practiced in accordance with aspects of the present disclosure. The device may be a mobile computing device, for example. One or more of the present embodiments may be implemented in an operating environment 800. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smartphones, network PCs, minicomputers, mainframe computers, distributed computing environments that include any of the above systems or devices, and the like.

In its most basic configuration, the operating environment 800 typically includes at least one processing unit 802 and memory 804. Depending on the exact configuration and type of computing device, memory 804 (e.g., instructions for generating a biometric hash as disclosed herein, etc.) may be volatile (such as RAM), non-volatile (such as ROM, flash memory, etc.), or some combination of the two. This most basic configuration is illustrated in FIG. 8 by dashed line 806. Further, the operating environment 800 may also include storage devices (removable, 808, and/or non-removable, 810) including, but not limited to, magnetic or optical disks or tape. Similarly, the operating environment 800 may also have input device(s) 814 such as remote controller, keyboard, mouse, pen, voice input, on-board sensors, etc. and/or output device(s) 812 such as a display, speakers, printer, motors, etc. Also included in the environment may be one or more communication connections 816, such as LAN, WAN, a near-field communications network, a cellular broadband network, point to point, etc.

Operating environment 800 typically includes at least some form of computer readable media. Computer readable media can be any available media that can be accessed by the at least one processing unit 802 or other devices comprising the operating environment. By way of example, and not limitation, computer readable media may comprise computer storage media and communication media. Computer storage media includes volatile and nonvolatile, removable and non-removable non-transitory media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media. Computer storage media does not include a carrier wave or other propagated or modulated data signal.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The operating environment 800 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

### Implementation Considerations and Example Variants

### Confidence Score Generation and Utilization

In certain embodiments, the analysis model or the custom model may be configured to generate a confidence score associated with each predicted attribute value. The confidence score may represent the model's certainty that a particular attribute value is correct, and may be computed using a softmax layer, a logit transformation, a probabilistic calibration function, or any other suitable technique for expressing classification certainty. In an example, the model may assign a “positive sentiment” label to a conversation with 92% confidence, and a “neutral sentiment” label with 6% confidence.

In some implementations, confidence scores may be presented to a user through the feedback interface, such as by displaying a percentage or a graphical element (e.g., a progress bar or shaded indicator) adjacent to each attribute value. The feedback interface may further use confidence scores to prioritize user attention toward low-confidence predictions, such as by highlighting predictions below a configurable threshold (e.g., less than 70% confidence). In other variants, confidence scores may be used internally by the system to determine whether to trigger model retraining, flag results for human review, or determine whether a custom model is eligible for deployment.

### Preprocessing of Conversation Objects

In some embodiments, prior to analysis by an analysis model or custom model, a conversation object may be preprocessed to produce a normalized representation suitable for attribute inference. The preprocessing may include one or more of: converting an audio recording to a transcript using a speech recognition engine; applying speaker diarization to label utterances by participant identity (e.g., “Customer” and “Agent”); removing filler words or disfluencies such as “um,” “uh,” “like,” or “you know”; redacting personally identifiable information (PII), such as names, phone numbers, or account numbers, and replacing the redacted content with tokens (e.g., “[REDACTED_NAME]”); and normalizing formatting or punctuation to conform to a standard input structure.

In some variants, the preprocessing pipeline may further segment the conversation into turns or utterances, with each turn annotated by a timestamp, speaker label, or other metadata. The resulting normalized transcript may be stored in association with the original conversation object, and may serve as the input to one or more natural language processing modules, including, but not limited to, the attribute analysis model, summarization model, or foundation model.

### Segment-Based Correction and Contextual Annotation

In certain embodiments, the feedback interface may enable an evaluator to associate corrections with specific segments of the conversation object. The feedback interface may allow the evaluator to select a span of the conversation (e.g., one or more utterances or character offsets), specify a corrected attribute value, and optionally provide a justification or explanation. For example, an evaluator may identify a segment in which the customer expresses frustration and correct a “neutral” sentiment prediction to “frustrated,” along with a justification stating “Customer was unhappy with shipping delay.”

In such embodiments, the system may store each correction as a refinement record comprising the conversation object identifier, the attribute under evaluation, the original and corrected attribute values, the segment reference (e.g., start and end offset or turn index), and any evaluator notes. These records may be used to train or fine-tune a custom analysis model and may enable the model to learn localized attribute patterns based on segment-level supervision.

### Foundation Model Prompt Engineering and Synthetic Data Generation

In certain embodiments, the system may utilize a foundation model to generate synthetic training data for refining an attribute prediction model. The foundation model may be a large language model (LLM) or other text generation model configured to receive a prompt that includes an example conversation object, an attribute definition, and optionally, a corrected attribute value. The prompt may be formulated using natural language instructions, structured examples, or embedded metadata to condition the generation process.

In one variant, the prompt may include a request such as: “Generate a customer support conversation in which the customer is expressing dissatisfaction with product quality. Label the conversation with the attribute ‘sentiment: negative.’” The foundation model may respond by generating a synthetically constructed conversation object that conforms to the target attribute value. In another variant, the system may prompt the foundation model with a corrected evaluator input and request variations that preserve the same attribute classification, thereby augmenting the training dataset with similarly labeled examples.

The system may further instruct the foundation model to vary specific dimensions of the conversation object during generation, including, but not limited to, tone, syntax complexity, topic specificity, and domain context. In some implementations, the foundation model may be configured to generate a distribution of examples that address underrepresented classes or attribute permutations, enabling the training of a more balanced and generalizable custom model.

### Negative Example Synthesis

In some implementations, the system may generate negative training examples to improve the discriminative capabilities of the custom analysis model. A negative example may comprise a conversation object paired with an incorrect attribute value, such that the model learns to distinguish between valid and invalid label assignments.

In one variant, the system may introduce controlled perturbations into an existing positively labeled example by modifying conversational tone, swapping entities, or inserting contradictory information, thereby generating a corresponding example with an intentionally incorrect attribute value. In another variant, the foundation model may be instructed to generate a conversation object that is semantically distinct from a known label pattern, and the system may pair this object with a label that is unlikely to apply.

The system may annotate each negative example with a flag or metadata indicator, and may optionally present such examples to evaluators to verify plausibility or to curate edge cases. During model training, the system may include both positive and negative examples within the same batch and may weight the loss function accordingly to penalize misclassification of either example type.

### Refinement Data Storage and Structuring

In certain embodiments, the system may maintain a structured refinement data repository for use in model training and evaluation. The refinement data may include evaluator-labeled attribute values, corrected values, synthetic training examples, segment annotations, and justification text. Each record in the refinement data repository may comprise a unique identifier, a reference to the corresponding conversation object, one or more attribute values (original and corrected), and any relevant metadata.

The repository may support per-entity partitioning, such that refinement data associated with one organization or domain is logically separated from data belonging to another. In some implementations, the repository may be indexed by attribute type, timestamp, evaluator ID, or conversation topic to facilitate targeted querying during training set construction. In other variants, the refinement data may be used to generate analytic reports or model quality dashboards.

### Deployment Evaluation and Model Lifecycle Management

In some embodiments, the system may deploy a custom analysis model when it satisfies one or more performance criteria relative to a generic baseline model. The system may evaluate model performance using a held-out validation dataset comprising conversation objects and evaluator-verified attribute values. The evaluation may compute performance metrics including, but not limited to, accuracy, precision, recall, F1-score, or other domain-specific measures.

A supervisor module may compare the performance of the custom model to a threshold value or to the performance of an existing analysis model. If the custom model outperforms the baseline according to a predefined selection policy, the system may deploy the custom model for production use. In some variants, the system may retain both the generic and custom models and apply them in parallel for comparison or ensemble prediction.

Model lifecycle events, including, but not limited to, training, evaluation, deployment, rollback, and retirement, may be orchestrated by the supervisor module based on the availability of refinement data, changes in attribute definitions, or shifts in model accuracy over time.

### Example: End-to-End Custom Model Refinement

In one illustrative embodiment, the system may be configured to improve the accuracy of sentiment classification for customer support conversations received by a retail organization. A conversation object is received by the system, wherein the conversation object comprises a multi-turn text transcript between a customer and a support agent. The transcript is derived from an audio recording processed by an automatic speech recognition engine and normalized by applying speaker diarization, punctuation correction, filler word removal, and redaction of personally identifiable information.

The normalized conversation object is analyzed by a generic analysis model, which outputs a first set of attribute values. In this example, the model predicts a sentiment value of “neutral” for the overall conversation. This prediction, along with a confidence score of 62%, is presented to a human evaluator via a graphical feedback interface. The evaluator, upon reviewing the transcript, identifies that the customer exhibited frustration due to multiple delivery delays, and updates the sentiment label to “frustrated.” The evaluator also highlights three segments of the transcript in which the customer explicitly voiced dissatisfaction and provides a justification: “Customer mentioned being upset about repeated shipping delays.”

The system stores this correction as a refinement data record, including, but not limited to, the conversation object identifier, the original and corrected attribute values, the associated segments, and the evaluator-provided justification. Upon accumulation of a threshold number of such corrections—e.g., ten annotated conversations referencing the “frustrated” sentiment label—the supervisor module initiates synthetic data generation using a foundation model.

The foundation model is prompted with selected corrected examples and instructed to generate additional conversation transcripts exhibiting “frustrated” customer tone in various contexts, such as product complaints, billing errors, and service outages. The model generates twenty synthetic conversation objects, each paired with the “frustrated” sentiment label and validated for coherence and attribute fidelity. The system further synthesizes five negative examples by altering tone in selected synthetic transcripts to remove expressions of frustration and pairing those modified versions with incorrect sentiment labels.

A custom analysis model is then trained using a combined dataset comprising the evaluator-corrected records, the foundation-model-generated synthetic examples, and the synthesized negative examples. The training process includes supervised optimization of a cross-entropy loss function with class balancing to account for previously underrepresented labels.

Upon completion of training, the supervisor module evaluates the custom model on a validation dataset comprising held-out evaluator-reviewed conversation objects. The model achieves an F1-score of 0.82 for the “frustrated” label, exceeding the generic model's F1-score of 0.63. The custom model is thereby selected for deployment and is thereafter used in production to analyze incoming conversation objects associated with the retail organization.

The system continues to monitor the performance of the deployed custom model and may initiate retraining or versioning in response to additional feedback, domain drift, or updated attribute definitions. In this manner, the system enables iterative refinement of attribute inference models based on limited human supervision and scalable synthetic augmentation.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

We claim:

1. A computer-implemented method for improving accuracy in conversation attribute analysis, the method comprising:
receiving, by a computing system comprising at least one processor, a conversation object comprising natural language data exchanged during a multi-turn interaction between a first participant and a second participant;
processing, by an analysis model executed by the computing system, the conversation object to generate a first set of attribute values, each attribute value corresponding to an attribute from a predefined set of attributes;
receiving, by the computing system via a feedback interface, a human evaluation of at least one attribute value of the first set, the human evaluation comprising a correction or confirmation of the attribute value;
generating, by a foundation model executed by the computing system, a plurality of synthetic training examples using the conversation object and the human evaluation, wherein each synthetic training example comprises a synthetically generated conversation object and a corresponding attribute value;
training, by the computing system, a custom analysis model using a training dataset comprising the synthetic training examples and the human evaluation; and
deploying, by the computing system, the custom analysis model to process subsequent conversation objects and generate corresponding attribute values.

2. The method of claim 1, wherein the conversation object is converted into a machine-readable representation comprising a normalized transcript, and wherein the normalized transcript excludes filler words, annotates speaker turns, and redacts personally identifiable information prior to processing by the analysis model.

3. The method of claim 1, wherein the predefined set of attributes comprises a plurality of communication-related attributes including sentiment, escalation risk, product mention detection, and compliance with predefined language policies.

4. The method of claim 3, wherein each attribute value is output in association with a confidence score computed by the analysis model, and wherein the feedback interface displays the confidence score to facilitate evaluator decision-making.

5. The method of claim 1, wherein the feedback interface includes selectable user interface elements enabling the evaluator to designate an attribute value as correct or incorrect, to select an alternate value from a predefined label set, or to input a freeform corrected value.

6. The method of claim 5, further comprising associating, by the computing system, each corrected attribute value with a corresponding conversational segment identified by the evaluator using a segment selection interface rendered within the feedback interface.

7. The method of claim 1, wherein the foundation model is a transformer-based large language model prompted with examples of evaluator-corrected attribute values to generate synthetic conversation object-attribute value pairs that reflect both correct and incorrect label patterns.

8. The method of claim 7, wherein the foundation model is further configured to generate a synthetically diversified corpus of training examples that vary in tone, syntax, sentiment strength, and topical focus to improve generalization of the custom analysis model.

9. The method of claim 1, wherein training the custom analysis model comprises fine-tuning a baseline analysis model architecture using a supervised training routine that minimizes a classification loss over the training dataset comprising the synthetic training examples and the human evaluation.

10. The method of claim 1, further comprising selecting, by a supervisor module of the computing system, the custom analysis model for deployment based on a model selection policy, the model selection policy comprising performance thresholds for accuracy, precision, and recall relative to a validation dataset comprising held-out evaluator-labeled conversation objects.

11. A non-transitory computer-readable medium storing instructions that, when executed by one or more processors of a computing system, cause the computing system to:
receive a conversation object comprising natural language content from a multi-turn dialogue between participants;
determine, using an analysis model, a plurality of attribute values for the conversation object, each attribute value corresponding to a respective attribute of a predefined attribute set;
display, via a feedback interface, the conversation object in association with the attribute values and receive user-provided evaluator feedback indicating correctness or corrections to one or more of the attribute values;
instruct a foundation model to generate synthetic training examples based on the conversation object and the evaluator feedback;
train a custom analysis model using a training dataset that includes the synthetic training examples and the evaluator feedback; and
use the custom analysis model to analyze additional conversation objects and produce corresponding attribute values.

12. The computer-readable medium of claim 11, wherein the instructions further cause the computing system to preprocess the conversation object by applying speaker diarization, stop word removal, and token-level redaction prior to analysis.

13. The computer-readable medium of claim 11, wherein the evaluator feedback includes a multi-step evaluation comprising attribute confirmation, value substitution, relevance justification, and conversational segment tagging, all received via the feedback interface.

14. The computer-readable medium of claim 11, wherein the synthetic training examples generated by the foundation model include both positive and negative examples, wherein negative examples represent known error modes of the analysis model based on prior evaluations.

15. The computer-readable medium of claim 11, wherein the custom analysis model is selected from a pool of candidate models based on a performance evaluation including cross-validated metrics and business-rule-based selection criteria implemented by a supervisor module.

16. A system for refining conversation attribute analysis using custom model training, the system comprising:
at least one processor; and
a non-transitory memory storing instructions that, when executed by the at least one processor, cause the system to perform actions comprising:
receive a conversation object comprising natural language data exchanged during a communication session;
analyze, using an analysis model, the conversation object to generate a first set of attribute values corresponding to a predefined set of attributes;
receive, via a user interface, a human evaluation of one or more attribute values, the evaluation comprising a correction or confirmation of each evaluated value;
generate, using a foundation model, a plurality of synthetic training examples comprising additional conversation object-attribute value pairs informed by the human evaluation;
train a custom analysis model using the synthetic training examples and the human evaluation; and
deploy the custom analysis model to generate attribute values for subsequent conversation objects.

17. The system of claim 16, wherein the analysis model is a multi-layer perceptron, and the custom analysis model is a fine-tuned variant of the same architecture trained using evaluator-verified and synthetic data.

18. The system of claim 16, wherein the user interface includes a feedback interface component configured to collect evaluator corrections along with justifications and conversational references, and store them in a structured refinement data repository.

19. The system of claim 16, wherein the foundation model is configured to sample across a structured prompt space to synthesize training data spanning attribute variants and domain-specific conversational themes.

20. The system of claim 16, further comprising a supervisor module configured to manage custom model lifecycles by initiating training upon detecting a threshold of refinement data volume has been satisfied, and to trigger model deployment based on comparative validation scores against baseline models.
